(19) United States
(12) Patent Application Publication
(10) Pub. No.: US 2022/0041214 A1
(43) Pub. Date: Feb. 10, 2022

(54) ANGLE SENSOR HAVING A TWO-POLE MAGNET FOR A MOTOR VEHICLE STEERING SYSTEM

(71) Applicants: thyssenkrupp Presta AG, Eschen (LI); thyssenkrupp AG, Essen (DE)

(72) Inventors: Péter PÁDÁR, Budapest (HU); Ábel VÉR, Solymár (HU)

(73) Assignees: thyssenkrupp Presta AG, Eschen (LI); thyssenkrupp AG, Essen (DE)

(21) Appl. No.: 17/276,190

(22) PCT Filed: Sep. 25, 2019
(86) PCT No.: PCT/EP2019/075833

§ 371 Date: Mar. 15, 2021

(30) Foreign Application Priority Data
Sep. 27, 2018 (DE) 10 2018 123 885.1

(51) Int. Cl. B62D 15/02; G01B 7/30; G01D 5/16

(52) U.S. Cl. CPC B62D 15/0215; G01D 5/16; G01B 7/30

(57) ABSTRACT

An angle sensor unit for measuring a rotational angle of a steering shaft may include a two-pole magnet that is disposed at one end of the steering shaft and has two poles that are opposite one another relative to a magnetic axis corresponding to a rotational axis of the steering shaft, two magnetic-field-direction-dependent magnetic field sensors assigned to the magnet and arranged with their sensitive sensor faces parallel to the external face of the magnet and at two different distances from the magnet and centers of the magnetic field sensors being located on the magnetic axis, and an evaluation unit configured to determine a rotational angle based on signals of the two magnetic field sensors and magnetic flux density, which is respectively present in a region of the two magnetic field sensors, of the magnetic field originating from the magnet.

The present invention relates to an angle sensor unit having the features of the preamble of claim 1, to an electromechanical power steering system and to a steer-by-wire steering system for a motor vehicle having the angle sensor unit and a method for determining a corrected rotational angle of the rotational position of a rotatably mounted steering shaft of a motor vehicle having the features of the preamble of claim 9.

Angle sensors are used in a motor vehicle, inter alia, to measure the steering angle of the steering wheel. Currently used angle sensors are magnetic sensors whose measurement can be very easily disrupted by external magnetic fields. Motor vehicles will in future be operated partially or completely electrically, and already are so to a certain extent, and this can bring about high external field effect measurements as a result of high-current-conducting cables which are frequently located in the vicinity of the steering system. This interference acting on the magnetic sensors can therefore have an adverse effect on the steering sensation and the robustness of the steering.

An object of the present invention is to specify an angle sensor unit which has improved accuracy and a reduced effect of an existing magnetic interference field on the determination of the rotational angle value.

This object is achieved by an angle sensor unit having the features of claim 1 and a method for determining a rotational angle of the rotational position of a rotor shaft of an electric motor of a motor vehicle steering system having the features of claim 9.

Accordingly, an angle sensor unit for measuring a rotational angle of the rotational position of a steering shaft of a motor vehicle is provided, having a two-pole magnet which can be connected to one end of the steering shaft in a torque-proof manner and which has two poles which are opposite one another with respect to a magnetic axis, wherein the magnetic axis corresponds to a rotational axis of the steering shaft. The angle sensor unit also has two magnetic-field-direction-dependent magnetic field sensors which are assigned to the magnet, wherein the two magnetic field sensors are arranged with their sensitive sensor faces parallel to the external face of the magnet and at two different distances from the magnet, and the centers of the magnetic field sensors are located on the magnetic axis. Furthermore, the angle sensor unit has an evaluation unit which is configured to determine a rotational angle on the basis of the signals of the two magnetic field sensors and the magnetic flux density, which is respectively present in the region of the two magnetic field sensors, of the magnetic field originating from the magnet. The flux densities of the magnetic field in the region of the two sensors can be calculated by means of the known geometry. The two magnetic-field-direction-dependent sensors permit leakage field interference to be eliminated through differential measurements, and therefore make it possible to determine an interference-free rotational angle, because it is assumed that the interference field is homogeneous in the region of both sensors. The distance between the magnetic field sensors is preferably between 1 and 5 mm. In this region it can be assumed that the external magnetic interference field is approximately the same.

The magnetic field sensors are preferably AMR, GMR or TMR.

In one preferred embodiment, the magnetic field sensors are arranged on opposite sides of a circuit board.

The two-pole magnet is preferably a permanent magnet.

The evaluation unit is preferably configured to determine a rotational angle independently of an external magnetic interference field by forming differences between the signals of the two magnetic field sensors.

Furthermore, an electromechanical power steering system for a motor vehicle is provided, comprising a steering shaft which is mounted so as to be rotatable about a steering shaft rotational axis and can take various rotational positions, an electric motor for assisting a steering movement and an angle sensor unit as mentioned above.

The abovementioned angle sensor unit can also be used in a steer-by-wire steering system for motor vehicles having a steering actuator which acts on the steered wheels and is electronically controlled as a function of a driver's steering request, a feedback actuator which transmits reactions of the road to a steering wheel, a control unit which actuates the feedback actuator and the steering actuator.

In addition, a method is provided for determining a corrected rotational angle of the rotational position of a rotationally mounted steering shaft of a motor vehicle with an angle sensor unit, having a two-pole magnet which can be connected in a torque-proof manner to one end of the steering shaft and which has two poles which are opposite one another with respect to a magnetic axis, wherein the magnetic axis corresponds to a rotational axis of the steering shaft, and the angle sensor unit also comprises two magnetic-field-direction-dependent magnetic field sensors which are assigned to the magnet, and an evaluation unit which is configured to determine a rotational angle by means of the signals of the two magnetic field sensors, wherein the two magnetic field sensors are arranged with their sensitive sensor faces parallel to the external face of the magnet and at two difference distances from the magnet, and the centers of the magnetic field sensors are located on the magnetic axis, and the method comprises the following steps:
Measuring a first magnetic field direction by means of the first magnetic field sensor in the form of sine and cosine signals,
Measuring a second magnetic field direction by means of the second magnetic field sensor in the form of sine and cosine signals,
Determining a first magnetic flux density of the magnetic field, originating from the magnet, in the region of the first magnetic field sensor,
Determining a second magnetic flux density of the magnetic field, originating from the magnet, in the region of the second magnetic flux sensor,
Forming a weighted difference between the respectively measured sine and cosine signals, wherein the weighting is carried out by means of the first and second magnetic flux densities, and
Determining the interference-free rotational angle from the difference signals independently of an external magnetic interference field by means of an arctan function.

Such an arctangent determination can be implemented, for example, on the basis of lookup tables, a CORDIC (Coordinate Rotation Digital Computer) algorithm or a similar implementation. The method provides the abovementioned advantages.

It is also possible to provide the following steps:
Determining a rotational angle from the signals of the respective sensor by means of an arctan function,
Checking the corrected rotational angle on the basis of the rotational angles determined from the signals of the sensors.

A plausibility check is preferably carried out during the checking, which passes on the corrected rotational angle to the motor controller only if said angle appears plausible.

The first and second magnetic flux densities are preferably calculated.

Preferred embodiments of the invention are explained in more detail below with reference to the drawings. Identical and functionally identical components are provided with the same reference symbols in all the figures here. In the drawings:

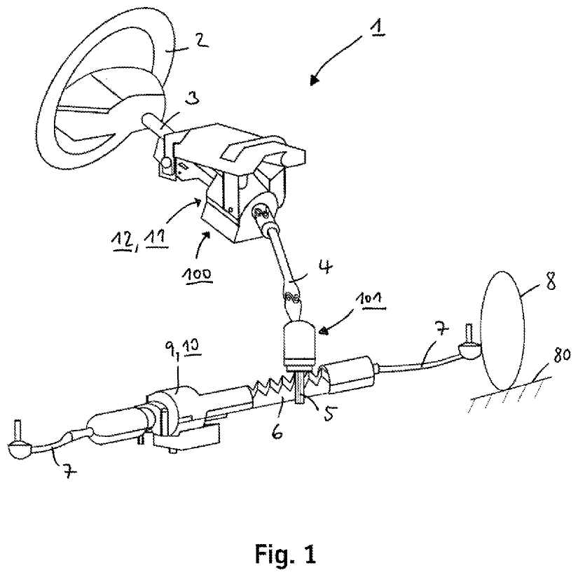

FIG. 1: shows a schematic illustration of an electromechanical motor vehicle steering system,

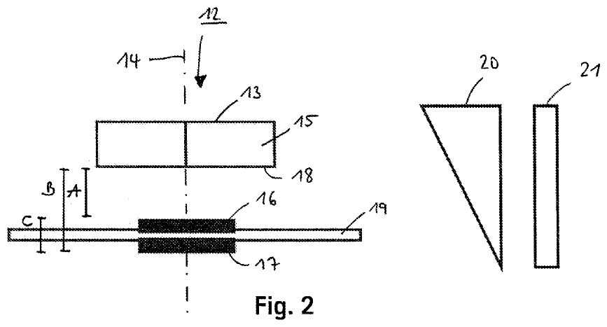

FIG. 2: shows a schematic illustration of a steering angle sensor according to the invention with two sensors and a two-pole magnet,

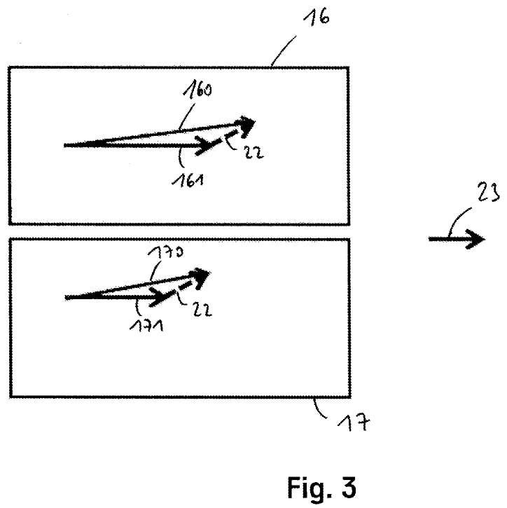

FIG. 3: shows a schematic illustration of the components of the magnetic field in the region of the two sensors, and

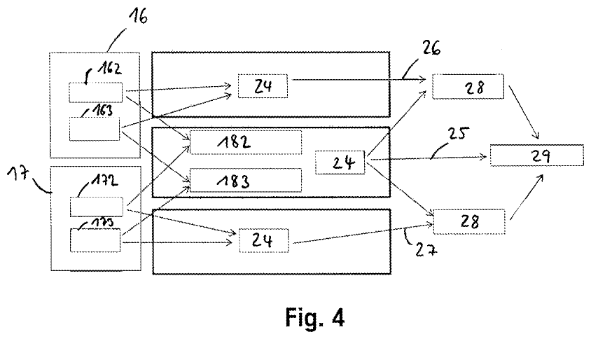

FIG. 4: shows a block diagram in relation to the calculation of the rotational angle by means of the rotational angle sensor in FIG. 2.

FIG. 1 schematically illustrates an electromechanical motor vehicle power steering system 1 with a steering wheel 2, which is coupled to a steering shaft 3 in a torque-proof manner. The driver applies a corresponding torque as a steering instruction into the steering shaft 3 via the steering wheel 2. The torque is then transmitted to a steering pinion 5 via the upper steering shaft 3 and the lower steering shaft 4. The pinion 5 meshes in the known fashion with a toothed segment of a steering rack 6. The steering rack 6 is mounted in a steering housing so as to be displaceable in the direction of its longitudinal axis. At its free end, the steering rack 6 is connected to tie rods 7 via ball and socket joints (not illustrated). The tie rods 7 are themselves connected to one steered wheel 8 each of the motor vehicle in a known fashion using stub axles. Rotation of the steering wheel 2 brings about longitudinal displacement of the steering rack 6 and therefore pivoting of the steered wheels 8 via the connection of the steering shaft 3 and of the pinion 5. The steered wheels 8 experience, via an underlying surface 80, a reaction which counteracts the steering movement. In order to pivot the wheels 8, force is consequently necessary which makes a corresponding torque necessary at the steering wheel 2. An electric motor 9 of a servo unit 10 is provided in order to assist the driver during this steering movement. The upper steering shaft 3 and the lower steering shaft 4 are connected to one another in a rotationally elastic fashion via a torsion bar (not shown). A torque sensor unit 11 senses the rotation of the upper steering shaft 3 with respect to a lower steering shaft 4 as a measure of the torque which is manually applied to the steering shaft 3 or the steering wheel 2. The torque sensor unit 11 comprises a steering angle sensor unit 12. The servo unit 10 makes available steering assistance for the driver as a function of the torque measured by the torque sensor unit 11. The servo unit 10 can be coupled here as a power steering device 10, 100, 101 to a steering shaft 3, the steering pinion 5 or the steering rack 6. The respective power steering system 10, 100, 101 inputs an auxiliary torque into the steering shaft 3, the steering pinion 5 and/or into the steering rack 6, as a result of which the driver is assisted during the steering work. The three different power steering devices 10, 100, 101 which are illustrated in FIG. 1 show alternative positions for their arrangement. Usually just one of the positions shown is allocated for a power steering system.

FIG. 2 is a schematic illustration of a steering angle sensor unit 12. A two-pole magnet 13 is arranged at one end of a shaft (not illustrated) and is connected thereto in a torque-proof manner. The shaft rotates about a rotational axis. The two-pole magnet 13 is a permanent magnet arrangement and is embodied in the form of a cube or plate and has two poles 15 (a pair of poles) which are diametrically opposite one another with respect to the rotational axis which corresponds to the magnetic axis 14.

Two magnetic-field-direction-dependent sensors 16,17 are provided which measure the direction of the magnetic field. These sensors are preferably AMR, GMR, TMR sensors or the like. The magnetic flux density of the magnetic field, originating from the two-pole magnet 13, in the region of the two sensors 16,17 is determined, preferably calculated. A first sensor 16 is arranged at a distance A from an external face 18 of the magnet 13, specifically in such a way that its center also lies on the magnetic axis 14. A second sensor is arranged at a distance B from the external face 18 of the magnet 13, also with its center on the magnetic axis 14. The two sensors 16,17 are preferably arranged on opposite sides of a circuit board 19 here and have a distance C between their sensitive sensor faces. The sensors 16,17 are positioned on the circuit board by means of SMD technology. The sensor faces are oriented parallel here to the external face 18 of the magnet 13. The two sensors 16,17 measure the components of the magnetic field which are perpendicular to one another, in the plane perpendicular to the rotational axis 14. By relative rotation of the magnet 13 about the rotational axis 14 the sensors 16,17 experience a change in the direction of the magnetic field and generate a corresponding output signal which is proportional to the current relative to the direction of the magnetic field with respect to the sensors 16,17. The determination of the angles is carried out by means of an arctangent function on the basis of the measured sine and cosine signals. The magnetic flux density of the magnetic fields generated by the permanent magnet 13 is different for the two sensors 16,17 owing to the different distances A,B, but the direction of the magnetic flux is the same. The reduction in the magnetic field strength 20 of the permanent magnet with the distance is illustrated in FIG. 2 at the right-hand edge in a schematic fashion as a triangle which comes to a point. If a magnetic interference field is then present as a result, for example, of high-current-conducting cables in the vicinity of the steering system, an interference-free signal can be formed by forming differences between the signals of the two sensors 16,17. This is because it can be assumed that the distance C between the sensitive sensor faces is so short that an external magnetic interference field is the same in the region of the two sensors. The constant magnetic field strength of the interference field 21 is also illustrated schematically in FIG. 2.

FIG. 3 shows a schematic view of the magnetic field vector 160,170 which is measured by the two sensors 16,17 and also occurs as an addition from the field vector of the magnetic field 161,171 originating from the permanent magnet, and the field vector of the interference field 22. The length of the magnetic field vectors 160,170 results from the flux density, present in the region of the sensors, of the magnetic field, which originates from the magnet 14, said flux density being known. The interference-free signal 23 is calculated, as illustrated in detail in FIG. 4. Accordingly, in each case the sine and cosine signals 162,172,163,173 of the two sensors 16,17 are subtracted from one another in a weighted fashion 182,183, in order to obtain interference-free signals. The two sensors 16,17 supply just one direction unit vector. Its length has to be adapted to the flux density of the interference-free magnetic field in the region of the sensors. The signals of the sensors 16,17 are therefore weighted, before the subtraction, by means of the information about the flux density. Subsequently, the corrected rotational angle 25 is calculated by means of the interference-free sine and cosine signals 182,183 using an arctan function 24. In addition, the rotational angle 26,27 is respectively determined from the signals of the two individual sensors for the cross check 28. If the interference-free corrected rotational angle 25 appears plausible in the cross check, it is transmitted to a motor controller 29 of an electric motor. If this is not the case, the conventionally determined rotational angles 26,27 can also be used for the motor controller. In the case of electromechanical power steering systems, a power steering system which is provided by means of electric motor is determined as a function of the rotational angle. However, it is also possible to provide for the steering angle sensor unit to be used in a steer-by-wire steering system.

1.-12. (canceled)

13. An angle sensor unit for measuring a rotational angle of a rotational position of a steering shaft of a motor vehicle, the angle sensor unit comprising:
a two-pole magnet that is connectable to an end of the steering shaft in a torque-proof manner, wherein the two-pole magnet includes two poles that are opposite one another relative to a magnetic axis that corresponds to a rotational axis of the steering shaft;
two magnetic-field-direction-dependent magnetic field sensors that are assigned to the two-pole magnet, wherein sensitive sensor faces of the two magnetic-field-direction-dependent magnetic field sensors are disposed parallel to an external face of the two-pole magnet and at two different distances from the two-pole magnet, wherein centers of the two magnetic-field-direction-dependent magnetic field sensors are disposed on the magnetic axis; and
an evaluation unit that is configured to determine the rotational angle based on signals of the two magnetic-field-direction-dependent magnetic field sensors and magnetic flux density, which is respectively present in a region of the two magnetic-field-direction-dependent magnetic field sensors, of a magnetic field originating from the two-pole magnet.

14. The angle sensor unit of claim 13 wherein a distance between the two magnetic-field-direction-dependent magnetic field sensors is between 1 mm and 5 mm.

15. The angle sensor unit of claim 13 wherein the two magnetic-field-direction-dependent magnetic field sensors are AMR, GMR, or TMR.

16. The angle sensor unit of claim 13 wherein the two magnetic-field-direction-dependent magnetic field sensors are disposed on opposite sides of a circuit board.

17. The angle sensor unit of claim 13 wherein the two-pole magnet is a permanent magnet.

18. The angle sensor unit of claim 13 wherein the evaluation unit is configured to determine a rotational angle independently of an external magnetic interference field by forming differences between the signals of the two magnetic-field-direction-dependent magnetic field sensors that are weighted by way of the magnetic flux density of the magnetic field originating from the two-pole magnet.

19. An electromechanical power steering system for a motor vehicle, the electromechanical power steering system comprising:
a steering shaft that is mounted rotatably about a steering shaft rotational axis, wherein the steering shaft is positionable in multiple rotational positions;
an electric motor for assisting a steering movement; and
an angle sensor unit comprising:
a two-pole magnet that is connectable to an end of the steering shaft in a torque-proof manner, wherein the two-pole magnet includes two poles that are opposite one another relative to a magnetic axis that corresponds to the steering shaft rotational axis,
two magnetic-field-direction-dependent magnetic field sensors that are assigned to the two-pole magnet, wherein sensitive sensor faces of the two magnetic-field-direction-dependent magnetic field sensors are disposed parallel to an external face of the two-pole magnet, wherein centers of the two magnetic-field-direction-dependent magnetic field sensors are disposed on the magnetic axis, and
an evaluation unit that is configured to determine a rotational angle of the steering shaft based on signals of the two magnetic-field-direction-dependent magnetic field sensors and magnetic flux density, which is respectively present in a region of the two magnetic-field-direction-dependent magnetic field sensors, of a magnetic field originating from the two-pole magnet.

20. A steer-by-wire steering system for motor vehicles, the steer-by-wire steering system comprising:
a steering actuator that acts on steered wheels and is electronically controlled as a function of a driver steering request;
a feedback actuator that transmits reactions of a road to a steering device;
a control unit that controls the feedback actuator and the steering actuator; and
an angle sensor unit that includes
a two-pole magnet that is connectable to an end of a steering shaft in a torque-proof manner, wherein the two-pole magnet includes two poles that are opposite one another relative to a magnetic axis that corresponds to a steering shaft rotational axis,
two magnetic-field-direction-dependent magnetic field sensors that are assigned to the two-pole magnet, wherein sensitive sensor faces of the two magnetic-field-direction-dependent magnetic field sensors are disposed parallel to an external face of the two-pole magnet, wherein centers of the two magnetic-field-direction-dependent magnetic field sensors are disposed on the magnetic axis, and
an evaluation unit that is configured to determine a rotational angle of the steering shaft based on signals of the two magnetic-field-direction-dependent magnetic field sensors and magnetic flux density, which is respectively present in a region of the two magnetic-field-direction-dependent magnetic field sensors, of a magnetic field originating from the two-pole magnet.

21. A method for determining a corrected rotational angle of a rotational position of a rotationally mounted steering shaft of a motor vehicle with an angle sensor unit that comprises:
a two-pole magnet that is connectable to an end of the steering shaft in a torque-proof manner, wherein the two-pole magnet includes two poles that are opposite one another relative to a magnetic axis that corresponds to a rotational axis of the steering shaft;
a first magnetic field sensor and a second magnetic field sensor configured as two magnetic-field-direction-dependent magnetic field sensors that are assigned to the two-pole magnet, wherein sensitive sensor faces of the two magnetic-field-direction-dependent magnetic field sensors are disposed parallel to an external face of the two-pole magnet and at two different distances from the two-pole magnet, wherein centers of the two magnetic-field-direction-dependent magnetic field sensors are disposed on the magnetic axis; and
an evaluation unit that is configured to determine a rotational angle of the rotationally mounted steering shaft based on signals of the two magnetic-field-direction-dependent magnetic field sensors,
wherein the method comprises:
measuring a first magnetic field direction by way of the first magnetic field sensor as sine and cosine signals;
measuring a second magnetic field direction by way of the second magnetic field sensor as sine and cosine signals;
determining a first magnetic flux density of a magnetic field originating from the two-pole magnet in a region of the first magnetic field sensor;
determining a second magnetic flux density of the magnetic field in a region of the second magnetic field sensor;
forming a weighted difference between the respectively measured sine and cosine signals, wherein the weighted difference is performed by way of the first and second magnetic flux densities; and
determining an interference-free rotational angle from the respectively measured sine and cosine signals independently of an external magnetic interference field by way of an arctan function.

22. The method of claim 21 comprising:
determining a rotational angle from signals of the respective magnetic field sensor by way of an arctan function; and
checking the corrected rotational angle based on the rotational angles determined from the signals of the first and second magnetic field sensors.

23. The method of claim 22 comprising using the corrected rotational angle in a motor controller if the corrected rotational angle is confirmed during the checking.

24. The method of claim 21 comprising calculating the first and second magnetic flux densities.
